(19) United States
(12) Patent Application Publication
(10) Pub. No.: US 2019/0291315 A1
(43) Pub. Date: Sep. 26, 2019

(54) METHOD OF FORMING A COMPOSITE ARTICLE

(71) Applicant: BASF SE, Ludwigshafen am Rhein (DE)

(72) Inventors: Raymond A. Neff, Bloomfield Hills, MI (US); Yunus Emre Kurtoglu, Plymouth, MI (US)

(21) Appl. No.: 16/317,699

(22) PCT Filed: Jul. 12, 2017
(86) PCT No.: PCT/US2017/041624

§ 371 Date: Jan. 14, 2019

Related U.S. Application Data
(60) Provisional application No. 62/362,268, filed on Jul. 14, 2016.

(51) Int. Cl. B29C 45/14; B29C 59/02; B29C 59/00

(52) U.S. Cl. CPC B29C 45/14221; B29K 2021/003; B29C 59/002; B29C 59/022

(57) ABSTRACT

A method of forming a composite article including a first portion comprising a cured elastomer and presenting an engagement surface, and a second portion comprising a thermoplastic composition and presenting a locking surface is disclosed. The method comprises the step of forming a plurality of engagement voids in the engagement surface of the first portion. Each engagement void penetrates into the engagement surface of the first portion and is defined by a side wall which forms an acute angle with the engagement surface. The method also includes the step of applying the thermoplastic composition onto the engagement surface of the first portion to form the second portion such that the locking surface abuts the engagement surface and defines a plurality of locking protrusions disposed in the plurality of engagement voids of the first portion.

### FIELD OF THE DISCLOSURE

The present disclosure generally relates to a method of forming a composite article comprising a first and a second portion.

### BACKGROUND OF THE DISCLOSURE

Composite articles often include one or more polymeric materials. In some embodiments, the use of different polymeric materials provides a composite article with performance properties which cannot be obtained with an article comprising a single polymeric material. For example, a composite article can include an elastomeric material (i.e. a rubber) that provides elasticity, and a thermoplastic which provides rigidity. As another example, a composite article can include an elastomeric material which provides elasticity, and a thermoplastic material which provides low permeability. As yet another example, a composite article can include an elastomeric material which provides elasticity and a thermoplastic material which provides low surface energy. Stated simply, composite articles can offer improved performance properties over articles formed with a single material.

Many composite articles require various layers or portions comprising different polymeric materials be attached, affixed, adhered, or bonded to one another. In some embodiments, the different polymeric materials can be mechanically attached to one another (e.g. attached to one another with screws). However, when different polymeric materials can be bonded directly to one another (e.g. attached to one another without screws) many advantages can be obtained with the composite article formed therefrom. For example, bonding materials directly to one another can (1) minimize design requirements, (2) reduce weight, (3) reduce vibration, (4) provide a seal, and (5) minimize the impact of thermal expansion.

Polymeric materials can be adhered to one another with an adhesive and/or thermally bonded (e.g. co-molded together). A primer can be used to treat the surfaces to be bonded or adhered to one another, or the surfaces to be bonded or adhered to one another can be pretreated (e.g. with a corona treatment) in an effort to improve the strength of the bond between the different polymeric materials.

However, not all polymeric materials adhere or bond well to one another. Various properties associated with the polymeric materials can provide performance properties such as elasticity for impact resistance, low surface energy for reduced friction, etc. These very properties can make it difficult to bond different polymeric materials together.

Despite the availability of various adhesives and methods for bonding different polymeric materials together, composite articles can fail under physical and/or environmental (e.g. thermal/high temperature) stress resulting in adhesive failure or delamination of the different polymeric materials. As such, there remains a need for improved methods of bonding different polymeric materials to one another to form composite articles.

### SUMMARY OF THE DISCLOSURE AND ADVANTAGES

The instant disclosure provides a composite article including a first portion and a second portion. The first portion comprises a cured elastomer and presents an engagement surface. The engagement surface defines a plurality of engagement voids. Each engagement void penetrates into the engagement surface of the first portion and is defined by a side wall which forms an acute angle with the engagement surface. The second portion comprises a thermoplastic composition and presents a locking surface.

The instant disclosure also provides a method of forming a composite article comprising the steps of forming a plurality of engagement voids in the engagement surface of the first portion, and applying the thermoplastic composition onto the engagement surface of the first portion to form the second portion such that the locking surface abuts the engagement surface and defines a plurality of locking protrusions disposed in the plurality of engagement voids of the first portion.

The method produces an engagement surface and locking surface which abut to provide a robust bond between the first portion comprising the cured elastomer and the second portion comprising the thermoplastic composition. The bond formed is flexible, durable, and resistant to failure under physical and environmental stress.

### BRIEF DESCRIPTION OF THE DRAWINGS

Other advantages of the present invention will be readily appreciated, as the same becomes better understood by reference to the following detailed description when considered in connection with the accompanying drawings.

FIG. 1 is an enlarged cross-sectional view of a composite article comprising a first and a second portion.

FIG. 2 is an isolated, enlarged, cross-sectional view of a first portion of the composite article including an engagement surface which defines a plurality of engagement voids.

FIG. 3 is an isolated, enlarged, cross-sectional view of a composite article including a first portion presenting an engagement surface which defines a plurality of engagement voids having different cross-sectional profiles.

FIG. 4 is a scanning electron microscope image of a surface of a portion which does not define a plurality of engagement voids.

FIG. 5 is a scanning electron microscope image of an engagement surface of a first portion which defines a plurality of engagement voids.

FIG. 6A is an isolated, enlarged, cross-sectional view of an initial portion comprising uncured elastomer.

FIG. 6B is an isolated, enlarged, cross-sectional view of a plurality of particles on a surface of the initial portion of FIG. 6A.

FIG. 6C is an isolated, enlarged, cross-sectional view of the plurality of particles of FIG. 6B pressed into the surface of the initial portion.

FIG. 6D is an isolated, enlarged, cross-sectional view of a first portion presenting the engagement surface which defines a plurality of engagement voids formed via curing the initial portion and dissolving the plurality of particles of FIG. 6C.

FIG. 6E shows a composite article comprising the first portion of FIG. 6D and a second portion presenting a locking surface which abuts the engagement surface.

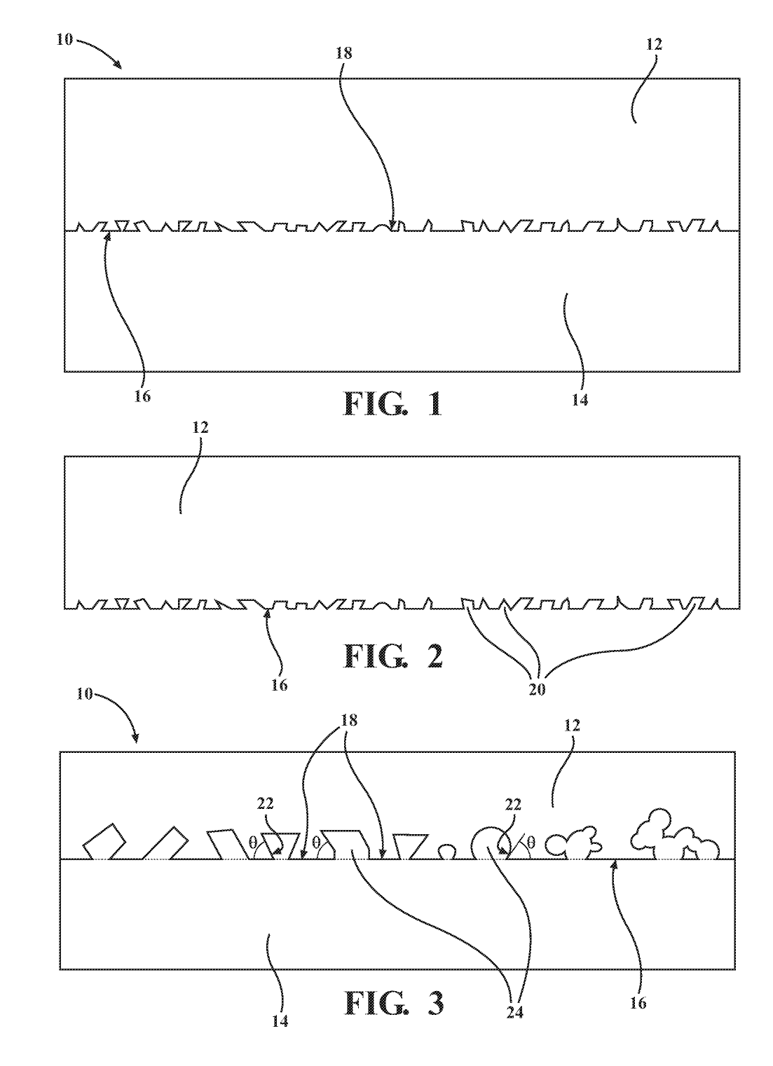

FIGS. 1 through 6E are exemplary in nature and are not drawn to scale and are, thus, not intended to represent the relative sizes of the various components of the composite article, e.g. the first portion, the second portion, the engagement surface, the engagement voids, etc.

### DETAILED DESCRIPTION OF THE DISCLOSURE

Referring to FIG. 1, wherein like numerals indicate corresponding parts throughout the several views, a composite article is generally shown at 10. The composite article 10 includes a first portion 12 and a second portion 14. The first portion 12 comprises a cured elastomer and presents an engagement surface 16. The second portion 14 comprises a thermoplastic composition and presents a locking surface 18.

FIG. 2 is an isolated, enlarged, cross-sectional view of the first portion 12 of the composite article 10 including the engagement surface 16. The engagement surface 16 defines a plurality of engagement voids 20. Each engagement void 20 penetrates into the engagement surface 16 of the first portion 12 and is defined by a side wall 22 which forms an acute angle e with the engagement surface 16.

FIG. 3 is an isolated, enlarged, cross-sectional view of the composite article 10 including the first portion 12 presenting the engagement surface 16 showing a plurality of engagement voids 20 having different cross-sectional profiles. A cross-sectional profile of each engagement void can define any suitable configuration, such as a circle, an oval, or any type of ellipse, a closed parabolic shape, a quadrilateral, or any other type of polygon. Each engagement void 20 penetrates into the engagement surface 16 of the first portion 12 and is defined by a side wall 22 which forms an acute angle e with the engagement surface 16. Various examples of this acute angle e which is formed with the engagement surface 16 are shown in FIG. 3. Notably, embodiments of the composite article 10 which do not have engagement voids 20 that form an acute angle e with the engagement surface 16 of the first portion 12 that are formed with the methods disclosed are contemplated herein. That is, embodiments of the composite article 10 having engagement voids 20 penetrating into the engagement surface 16 of the first portion 12 and defined by a side wall 22 which forms an angle e which is right, obtuse, and/or acute, with the engagement surface 16 are also contemplated. The cross-sectional profile of the plurality of engagement voids 20 typically depends on how the voids 20 are formed. For example, if the plurality of engagement voids 20 are formed with a salt, such as NaCl, the plurality of engagement voids 20 typically have a rectangular or triangular cross-sectional profile. If the plurality of engagement voids 20 are formed with a blowing agent, such as azodicarbonamide, the plurality of engagement voids 20 typically have an ovular cross-section profile. The configuration of the plurality of engagement voids 20 can be random, semi-random, or patterned as desired.

FIG. 3 also shows the second portion 14 presenting the locking surface 18 abutting the engagement surface 16 and defining a plurality of locking protrusions 24 disposed in the plurality of engagement voids 20 of the first portion 12.

The composite article 10 can be used in a wide array of commercial products. In one embodiment, the composite article 10 is incorporated into a wheel assembly comprising a rubber tire tread (e.g. comprising cured elastomer) and a shear band and spokes (e.g. an elastomeric or thermoplastic polyurethane). It is to be appreciated that the composite article 10 of the subject disclosure can also have applications not specifically set forth herein.

A method of forming a composite article 10 comprising the first and the second portions 12, 14 is disclosed. The method includes the steps of forming a plurality of engagement voids 20 in the engagement surface 16 of the first portion 12, applying the thermoplastic composition onto the engagement surface 16 of the first portion 12 to form the second portion 14 such that the locking surface 18 abuts the engagement surface 16 and defines the plurality of locking protrusions 24 disposed in the plurality of engagement voids 20 of the first portion 12.

The first portion 12 is formed from an initial portion 26 comprising an elastomeric composition. The elastomeric composition comprises, or consists essentially of, an elastomer/rubber. Of course, one or more types of elastomer may be included in the elastomeric composition. In many embodiments, the elastomeric composition comprises an elastomer selected from natural polyisoprene, synthetic polyisoprene, polybutadiene, chloroprene rubber, butyl rubber, halogenated butyl rubber, styrene-butadiene rubber (SBR), nitrile rubber, ethylene propylene rubber, ethylene propylene diene rubber (EPDM), epichlorohydrin rubber, polyacrylic rubber, silicone rubber, fluorosilicone rubber, fluoroelastomers, perfluoroelastomers, polyether block amides, chlorosulfonated polyethylene, and ethylene-vinyl acetate. The elastomeric composition may also comprise ingredients such as fillers, plasticizers, curatives, and additives.

Various additives can be included in the elastomeric composition. Suitable additives include, but are not limited to, processing additives, plasticizers, chain terminators, surface-active agents, adhesion promoters, flame retardants, anti-oxidants, water scavengers, dyes, ultraviolet light stabilizers, fillers, acidifiers, thixotropic agents, curatives/cross-linkers (e.g. sulfur based, or peroxide based), catalysts, blowing agents (as described in detail below), surfactants, and combinations thereof. The additive(s) may be included in any amount as desired by those of skill in the art.

Of course, the elastomeric composition is cured or cures (e.g. via heat, UV, inclusion of a room temperature cure package in the elastomeric composition, etc.) to form the first portion 12 comprising the cured elastomer. In a preferred embodiment, the elastomeric composition comprises ethylene styrene butadiene rubber (i.e. the cured elastomer comprises cured SBR).

In some embodiments, the elastomeric composition has a specific gravity of from about 0.9 to about 2.5, alternatively from about 1.2 to about 2.1, alternatively from about 1.5 to about 2.0, g/cm³.

With specific regard to the strength and elasticity, in some embodiments, the elastomeric composition can have a tensile strength at 50% elongation of from about 5 to about 50, alternatively from about 8 to about 40, alternatively from about 10 to about 30, MPa when tested in accordance with ISO 527. In some embodiments, the elastomeric composition can have an elongation at break of greater than about 200, alternatively from about 300 to about 700, alternatively from about 350 to about 600, alternatively from about 350 to about 450, % when tested in accordance with ISO 527.

In some embodiments, the step of forming the plurality of engagement voids 20 comprises the steps of: pressing a plurality of particles 30 into a surface 28 of an initial portion 26 comprising uncured elastomer; curing the initial portion 26 to form the first portion 12 comprising the cured elastomer with the plurality of particles 30 pressed therein; and dissolving the plurality of particles 30 in a solvent thereby forming the plurality of engagement voids 20 in the first portion 12 comprising cured elastomer.

In such embodiments, the plurality of particles 30 can comprise any material that can be dissolved or extracted with a liquid or gas solvent. In many embodiments, the particles 30 have a solubility of greater than about 1, alternatively greater than about 3, alternatively greater than about 6, alternatively greater than 10, g per 100 mL of the solvent at standard temperature and pressure. In preferred embodiments, the particles 30 comprise a salt selected from the group of nitrates, sulfates, chlorides, bromides, iodides, sodium carbonate, potassium carbonate, ammonium carbonate, sodium hydroxide, potassium hydroxide, ammonium hydroxide. In one particular embodiment, the particles 30 comprise sodium chloride.

In such embodiments, the plurality of particles 30 have an average diameter of from about 10 to about 500, alternatively from about 20 to about 400, alternatively from about 50 to about 300, μm. The particles 30 can be of various shapes and sizes. For example, the particles 30 can be circular, ovular, triangular, rectangular, etc. In some embodiments, one, two, three, or even more size populations of particles 30 can be pressed into the initial portion 26.

The plurality of particles 30 can be pressed into the initial portion 26 in various amounts based on the area of the surface 28. In some embodiments, the plurality of particles 30 are used in an amount sufficient to form a first portion 12 which defines from about 10 to about 450, alternatively from about 10 to about 350, alternatively from about 10 to about 250, alternatively from about 10 to about 150, engagement voids 20 per cm² of the engagement surface 16.

The plurality of particles 30 can be pressed into the surface 28 of the initial portion 26 comprising uncured elastomer with a press, a roller, or by any other effective means. The method can include the step of heating the particles 30, the press, or the roller to a temperature of from about 25 to about 350, alternatively from about 50 to about 250, alternatively from about 50 to about 150, ° C. prior to the step of pressing the plurality of particles 30 into the surface 28 of an initial portion 26. In embodiments where the particles are pre-heated, the elevated temperature of the particles helps cure the side wall 22 of the engagement voids 20 which, in-turn, helps form engagement voids 20 which maintain their shape and are resistant to collapse. In various embodiments, the initial portion 26 comprising uncured elastomer is heated from about 50 to about 150, ° C. prior to the step of pressing the plurality of particles 30 into the surface 28 of an initial portion 26.

Once the plurality of particles 30 is pressed into the surface 28 of the initial portion 26 comprising uncured elastomer, the initial portion 26 is cured to form the first portion 12 comprising the cured elastomer with the plurality of particles 30 pressed therein. The step of curing can be conducted via heat and/or ultraviolet radiation. When the initial portion 26 is cured via heat, the initial portion 26 can be cured to form the first portion 12 comprising the cured elastomer with the plurality of particles 30 pressed therein at a temperature of from about 50 to about 250, alternatively from about 100 to about 220, ° C., and a time of from about 10 to about 60, alternatively from about 20 to about 40, min.

Once cured, the plurality of particles 30 are dissolved in a solvent thereby forming the plurality of engagement voids 20 in the first portion 12 comprising cured elastomer. The solvent can be any liquid or gas that can dissolve or extract the particles 30. To this end, the solvent is selected in conjunction with the composition of the plurality of particles 30.

In some embodiments, the solvent is a polar solvent. The solvent having a dielectric constant of about 15 or greater is considered to be a “polar” solvent for purposes of the subject disclosure. The polar solvent can be aprotic or protic. Suitable non-limiting polar aprotic solvents for purposes of the subject disclosure include triethyl phosphate, tetrahydrofuran, ethyl acetate, acetone, dimethylformamide, acetonitrile, dimethyl sulfoxide, nitromethane, and propylene carbonate. Suitable non-limiting polar aprotic solvents for purposes of the subject disclosure include formic acid, n-butanol, isopropanol, n-propanol, ethanol, methanol, acetic acid, and water. In a preferred embodiment, the solvent comprises water.

In some embodiments, the solvent is a non-polar solvent. The solvent having a dielectric constant of less than 15 is considered to be a “non-polar” solvent for purposes of the subject disclosure. Suitable non-limiting non-polar solvents for purposes of the subject disclosure include pentane, cyclopentane, hexane, cyclohexane, benzene, toluene, 1,4-dioxane, chloroform, diethyl ether, and dichloromethane.

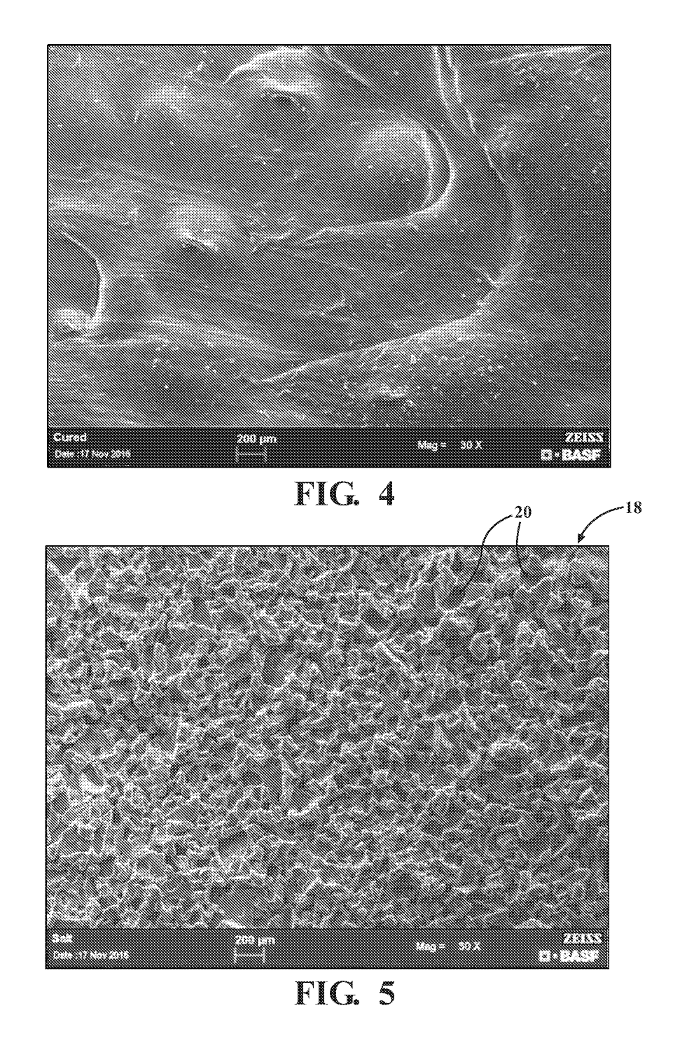

FIG. 4 is a scanning electron microscope (“SEM”) image of an engagement surface 16 which is formed when a plurality of particles 30 (of NaCl) are pressed into the surface 28 of the initial portion 26, the plurality of particles 30 is dissolved, and then the initial portion 26 is cured to form the first portion 12. In FIG. 4, the engagement voids 20 are not properly formed because the engagement voids 20 are diminished due to the viscoelastic flow of the uncured elastomer after the particles 30 are dissolved and during curing. In contrast, FIG. 5 is an SEM image of an engagement surface 16 which is formed when the plurality of particles 30 is pressed into the surface 28 of the initial portion 26, the initial portion 26 with the plurality of particles 30 pressed therein is cured to form the first portion 12 comprising the cured elastomer with the plurality of particles 30 pressed therein, and then the plurality of particles 30 is dissolved in the solvent to form the plurality of engagement voids 20 in the first portion 12 comprising cured elastomer. The engagement surface 16 shown in FIG. 5 has a plurality of distinct engagement voids 20 which provide for excellent adhesion with the second portion 14.

The process of the subject application may also form an engagement surface 16 which defines a plurality of voids that are different than the plurality of engagement voids 20. Each of these different voids defines an opening in the engagement surface 16, penetrates into the first portion 12, and is defined by a side wall 22 which does not form an acute angle e with the engagement surface 16. In such embodiments, once the thermoplastic is applied, the second portion 14 defines the plurality of locking protrusions 24 disposed in the plurality of different voids. In other words, the engagement surface 16 can include additional voids and surface patterns which are different than the engagement voids 20.

In various embodiments, the method includes the step of pre-treating the engagement surface 16 to improve the wet/out and or adhesion of the second portion 14 to the first portion 12. In some embodiments the engagement surface 16 is treated with a corona treatment. In other embodiments, the engagement surface 16 is treated with chemical primer.

A thermoplastic (e.g. a TPU) is then applied to the engagement surface 16 of the first portion 12 (e.g. co-molded with the first portion 12 in an injection molding machine) to form the second portion 14 thereby forming the composite article 10. The engagement surface 16 of the first portion 12 abuts the locking surface 18 of the second portion 14. More specifically, the locking surface 18 of the second portion 14 abuts the engagement surface 16 and defines the plurality of locking protrusions 24 disposed in the plurality of engagement voids 20 of the first portion 12.

The thermoplastic can be applied on the engagement surface 16 via press, mill, roller, vacuum, co-extrusion, injection molding, and compression molding. In a preferred embodiment, the second portion 14 is co-molded with the first portion 12. For example, the thermoplastic material is applied to the engagement surface 16 via injection molding.

More specifically, the second portion 14 comprises a thermoplastic composition. The thermoplastic composition comprises, consists essentially of, or consists of, a thermoplastic (thermoplastic as described herein includes thermoplastic elastomers). Of course, one or more types of thermoplastic may be included in the thermoplastic composition. In many embodiments, the thermoplastic composition comprises or consists essentially of a thermoplastic or a thermoplastic elastomer selected from polyethylene, polypropylene, polyamide, or thermoplastic polyurethane. In many embodiments, the thermoplastic composition comprises a thermoplastic elastomer selected from styrenic block copolymers, thermoplastic olefins (e.g. polyolefins), elastomeric alloys, thermoplastic polyurethanes, thermoplastic copolyester, and thermoplastic polyamides. In a preferred embodiment, the thermoplastic composition comprises thermoplastic polyurethane or TPU. In many embodiments, the thermoplastic composition also comprises or consists essentially of a polyolefin, i.e., a polyalkene. In some embodiments, the polyolefin can be selected from polyethylene, polypropylene, polymethylpentene, and polybutene-1. In other embodiments, the polyolefin can also be selected from polyolefin elastomers such as polyisobutylene, ethylene propylene rubber, ethylene propylene diene monomer rubber, and poly vinyl chloride. The thermoplastic composition may also comprise ingredients such as fillers, plasticizers, curatives, and additives.

In embodiments where the thermoplastic composition comprises a TPU, the thermoplastic composition may include one or more types of TPU. The TPU typically comprises the reaction product of a polyol, an isocyanate, and a chain extender. The TPU may comprise the reaction of one or more types of the polyol with one or more types of the isocyanate. The polyol can be any polyol known in the art. The polyol includes one or more OH functional groups, typically at least two OH functional groups. In various embodiments, the polyol is selected from the group of polyether polyols, polyester polyols, polyether/ester polyols, silicone polyols, fluorinated polyols, biopolyols, polytetrahydrofuran, and combinations thereof; however, other polyols may also be employed.

In various embodiments, a polyester polyol is reacted with the isocyanate to form a polyester-based TPU. Of course, various combinations of different polyols can be reacted to form the polyester-based TPU. Suitable polyester polyols may be produced from a reaction of a dicarboxylic acid and a glycol having at least one primary hydroxyl group. Suitable dicarboxylic acids may be selected from, but are not limited to, the group of adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols that are suitable for use in producing the polyester polyols may be selected from, but are not limited to, the group of ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof.

In various embodiments, a polyether polyol is reacted with the isocyanate to form a polyester-based TPU. Of course, various combinations of different polyols can be reacted to form the polyester-based TPU. In other words, the TPU of this embodiment is a polyether-based TPU comprising the reaction product of a polyether polyol and an isocyanate. Suitable polyether polyols may be selected from, but are not limited to, the group of polytetramethylene glycol, polyethylene glycol, polypropylene glycol, and combinations thereof.

In various embodiments, a polytetrahydrofuran (polyTHF) is reacted with the isocyanate to form the TPU. PolyTHF is synthesized by the polymerization of tetrahydrofuran. The polyTHF and one or more additional polyols can be reacted with the isocyanate to form the TPU. Of course, various combinations of different polyols can be reacted to form the TPU. For example, the polyTHF and a polyether polyol can be reacted to form the TPU. One or more types of the polyTHF can be reacted to form the TPU. The polyTHF is also known in the art as poly(tetramethylene ether) glycol or poly(tetramethylene oxide) and, in some embodiments, has the following general structure:

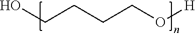

wherein n is an integer of from about 1 to about 100, alternatively from about 5 to about 75, alternatively from about 5 to about 50, alternatively from about 5 to about 20. Alternatively, in such embodiments, the polyTHF can have a weight average molecular weight of from about 225 to about 3000, alternatively from about 225 to about 275, alternatively from about 625 to about 675, alternatively from about 950 to about 1050, alternatively from about 1750 to about 1850, alternatively from about 1950 to about 2050, alternatively from about 2800 to about 3000, g/mol. In these embodiments, the polyol can have a hydroxyl number of from about 30 to about 1000, alternatively from about 498 to about 537.4, alternatively from about 408 to about 498.7, alternatively from about 166.2 to about 179.5, alternatively from about 106.9 to about 118.1, alternatively from about 60.6 to about 64.1, alternatively from about 54.7 to about 57.5, alternatively from about 34.7 to about 40.1, mg KOH/g.

The isocyanate used to form the TPU may be a polyisocyanate having two or more functional groups, e.g. two or more NCO functional groups. In various embodiments, the isocyanate may include, but is not limited to, monoisocyanates, diisocyanates, polyisocyanates, biurets of isocyanates and polyisocyanates, isocyanurates of isocyanates and polyisocyanates, isocyanate prepolymers, and combinations thereof. Suitable isocyanates include, but are not limited to, aliphatic and aromatic isocyanates. In various embodiments, the isocyanate is selected from the group of diphenylmethane diisocyanates (MDIs), polymeric diphenylmethane diisocyanates (pMDIs), toluene diisocyanates (TDIs), hexamethylene diisocyanates (HDIs), isophorone diisocyanates (IPDIs), isocyanate prepolymers, and combinations thereof.

The isocyanate may comprise an isocyanate prepolymer. The isocyanate prepolymer is typically a reaction product of an isocyanate and a polyol and/or a polyamine. The isocyanate used in the prepolymer can be any isocyanate as described above. The polyol used to form the prepolymer is typically selected from the group of ethylene glycol, diethylene glycol, propylene glycol, dipropylene glycol, butane diol, glycerol, trimethylolpropane, triethanolamine, pentaerythritol, sorbitol, biopolyols, and combinations thereof. The polyamine used to form the prepolymer is typically selected from the group of ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof.

In some embodiments, the isocyanate may comprise an isocyanurated HDI, such as HDI isocyanural. Isocyanurated HDIs, which are typically highly functional low-viscosity isocyanates, react with the bioresin component to form a coating which has excellent UV, chemical, and solvent resistance, has excellent adhesion and durability, and is hard yet flexible. In one such embodiment, the isocyanate has an NCO content of from about 21.5 to about 22.5 weight percent, a viscosity at 23° C. of from about 2,500 to about 4,500 mPa·sec, and a percent solids of about 100 weight percent.

Specific isocyanates that may be used include, but are not limited to, toluene diisocyanate; 4,4′-diphenylmethane diisocyanate; m-phenylene diisocyanate; 1,5-naphthalene diisocyanate; 4-chloro-1; 3-phenylene diisocyanate; tetram ethylene diisocyanate; hexamethylene diisocyanate; 1,4-dicyclohexyl diisocyanate; 1,4-cyclohexyl diisocyanate, 2,4,6-toluylene triisocyanate, 1,3-diisopropylphenylene-2,4-dissocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, and 1,3,5-triisopropyl benzene-2,4,6-triisocyanate. Other suitable polyamide imide coatings can also be prepared from aromatic diisocyanates or isocyanates having one or two aryl, alkyl, arylalkyl or alkoxy substituents wherein at least one of these substituents has at least two carbon atoms. Of course, various combinations of the isocyanates referenced herein can be used to form the TPU.

The chain extender used to form the TPU may be selected from the group of, but are not limited to, diols, triols, and tetraols. Suitable diols include, but are not limited to, ethylene glycol, propylene glycol, butylene glycol, 1,4-butanediol (BDO), butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), hexanediol, and thiodiglycol; diamines including ethylene diamine, propylene diamine, butylene diamine, hexamethylene diamine, cyclohexalene diamine, phenylene diamine, tolylene diamine, xylylene diamine, 3,3′-dichlorobenzidine, and 3,3′-dinitrobenzidine; alkanol amines including ethanol amine, aminopropyl alcohol, 2,2-dimethyl propanol amine, 3-aminocyclohexyl alcohol, and p-aminobenzyl alcohol; and combinations of any of the aforementioned chain extenders. Other suitable chain extenders include glycerine, trimethylolpropane (TMP), and pentaerythritol.

In some embodiments, the TPU has a glass transition temperature (Tg) of from about −15 to about −50° C., alternatively from about −30 to about −40, ° C. and/or a Vicat Softening Temperature of greater than about 100° C., alternatively of from about 120 to about 160° C. when tested in accordance with ASTM D 1525.

Suitable TPU's are commercially available from BASF Corporation of Florham Park, N.J. under the trade name Elastollan®.

In some embodiments, the thermoplastic composition is relatively low density. That is, in some embodiments, the thermoplastic composition has a specific gravity of from about 0.8 to about 1.9, alternatively from about 0.9 to about 1.60, alternatively from about 1.0 to about 1.3, g/cm³.

In some embodiments, thermoplastic composition has a melt flow rate of from about 0.5 to about 15, alternatively from about 1 to about 10, alternatively from about 1 to about 5, g/10 minutes when tested in accordance with ISO 1133 and has a flexural modulus at a room temperature of from about 350 to about 700, alternatively from about 450 to about 600, alternatively from about 500 to about 550, MPa when tested in accordance with ISO 178.

In some embodiment, with specific regard to the strength and elasticity, the second portion 14 can have a tensile strength at 50% elongation of from about 5 to about 50, alternatively from about 8 to about 40, alternatively from about 10 to about 30, MPa when tested in accordance with ISO 527. The second portion 14 can have an elongation at break of greater than about 200, alternatively from about 300 to about 700, alternatively from about 350 to about 600, alternatively from about 350 to about 450, % when tested in accordance with ISO 527.

In various embodiments, the thermoplastic composition has a Shore hardness of from about 70 Shore A to about 80 Shore D.

In some embodiments, the thermoplastic composition has a Shore hardness of from about 70 to about 98 Shore A, a tensile strength of about 10 to about 80 MPa, an elongation at break of about 500 to about 700%, a melt flow rate of about 10 to about 100 g/10 min at 190° C., 22.6 kg. In other embodiments, the thermoplastic composition has a Shore hardness of from about 54 to about 80 Shore D, a tensile strength of about 20 to about 100 MPa, an elongation of about 300%, and a melt flow rate of from about 20 to about 200 g/10 min at 220° C., 22.6 kg.

In yet other embodiments, the thermoplastic composition has a Shore hardness of from about 70 to about 90 Shore D, a tensile strength of about 20 to about 100 MPa, and an elongation of from about 10 to about 50. In such embodiments, the thermoplastic composition could further be defined as a two-component cast elastomer thermoset (e.g. a polyurethane).

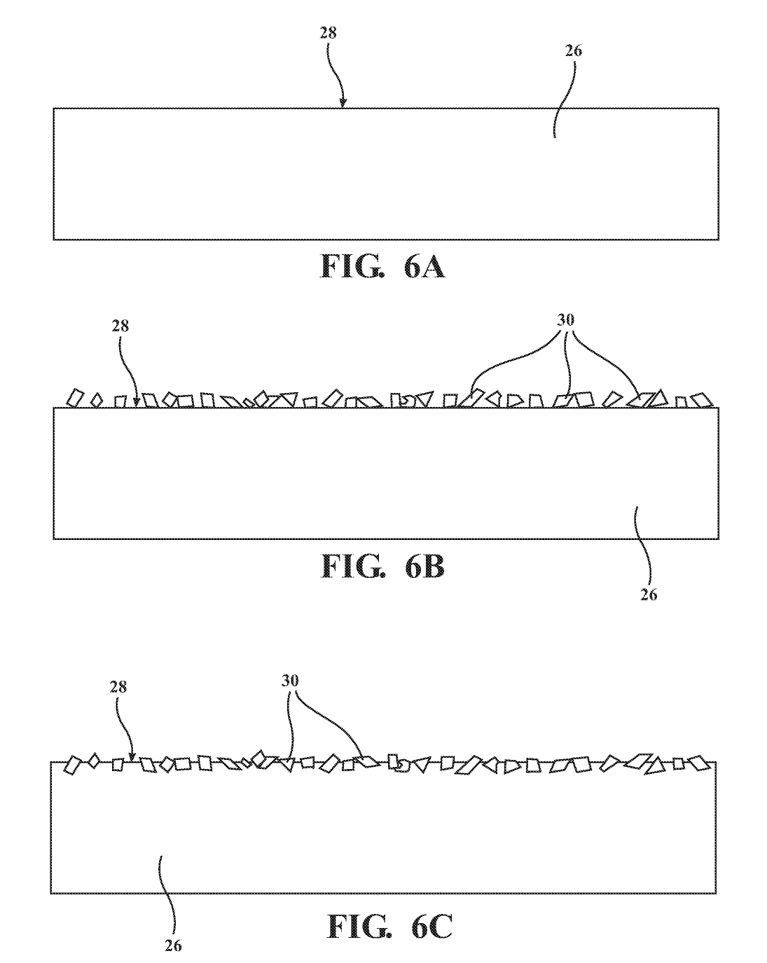

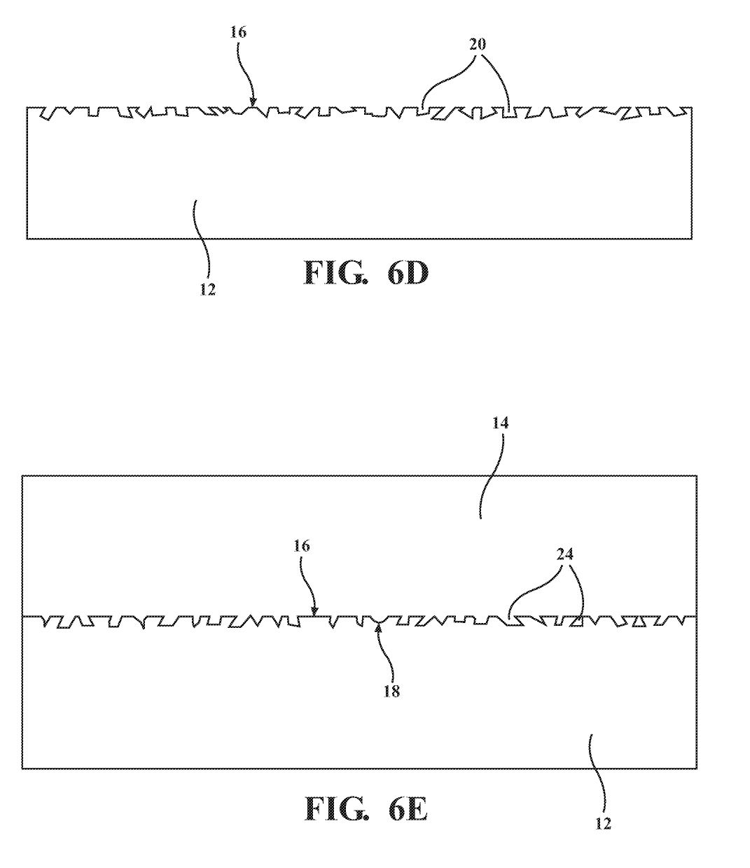

Referring now to FIGS. 6A-E, one embodiment of the subject method is described. FIG. 6A shows the initial portion 26 comprising uncured elastomer (e.g. comprising an uncured EPDM composition). FIG. 6B shows the plurality of particles 30 (e.g. NaCl) on a surface 28 of the initial portion 26. FIG. 6C shows the plurality of particles 30 pressed into the surface 28 of the initial portion 26. After the initial portion 26 with the plurality of particles 30 pressed therein is cured to form the first portion 12 comprising the cured elastomer with the plurality of particles 30 pressed therein, the plurality of particles 30 is dissolved in the solvent to form the plurality of engagement voids 20 in the first portion 12 comprising cured elastomer. That is, the plurality of engagement voids 20 is formed in the first portion 12 wherein each engagement void 20 penetrates into the engagement surface 16 of the first portion 12. FIG. 6D shows the first portion 12 presenting the engagement surface 16 which defines a plurality of engagement voids 20 formed when the particles 30 were dissolved. A thermoplastic (e.g. a TPU) is then applied to the engagement surface 16 of the first portion 12 (e.g. co-molded with the first portion 12 in an injection molding machine) to form the second portion 14. FIG. 6E shows the composite article 10 comprising the first portion 12 and the second portion 14. The first portion 12 comprises the cured elastomer and presents an engagement surface 16. The second portion 14 comprises a thermoplastic composition and presents the locking surface 18. The locking surface 18 abuts the engagement surface 16 and defines the plurality of locking protrusions 24 disposed in the plurality of engagement voids 20 of the first portion 12.

In some alternative embodiments, the step of forming the plurality of engagement voids 20 further comprises the steps of pressing a plurality of particles 30 into a surface 28 of an initial portion 26 comprising uncured elastomer, curing the initial portion 26 to form the first portion 12 comprising the cured elastomer with the plurality of particles 30 therein, and melting the plurality of particles 30 thereby forming the plurality of engagement voids 20 in the first portion 12 comprising cured elastomer. In such embodiments, once melted, the molten particles 30 can be removed from the engagement voids 20 gravimetrically, with an air knife, or in various other ways. In such embodiments, the particles 30 are just as described above with diameter, amount used, etc. However, in these embodiments, the particles 30 typically have a melting temperature of from about 100 to about 250, alternatively from about 125 to about 225, ° C. In this embodiment, the elastomeric composition can be cured (e.g. at a temperature as set forth in the temperature ranges above) and the elastomeric composition can be foamed simultaneously. That is, in various embodiments of this method, the steps of curing and foaming are conducted simultaneously. In such embodiments, the melting and cure temperatures can be selected so that two steps can be completed simultaneously in an efficient process. For example, in one non-limiting embodiment, the particles 30 can comprise a crystalline wax which melts and flows out of the engagement voids 20 during the step of curing. For example, in another non-limiting embodiment, the particles 30 can comprise a thermoplastic (e.g. polypropylene or polyethylene) which melts and flows out of the engagement voids 20 during the step of curing. The particles should melt over the range of curing temperatures of the uncured elastomer (e.g. at a temperature greater than 130° C.).

In other alternative embodiments, the step of forming a plurality of engagement voids 20 comprises the steps of foaming a surface 28 of an initial portion 26 comprising uncured elastomer, curing the initial portion 26 to form the plurality of engagement voids 20 in the first portion 12 comprising cured elastomer. In this embodiment, the elastomeric composition can be cured (e.g. at a temperature as set forth in the temperature ranges above) and the blowing agent can be foamed simultaneously. That is, in various embodiments of this method, the steps of curing and foaming are conducted simultaneously. In such embodiments, the curing and foaming (decomposition) temperatures can be selected so that two steps can be completed simultaneously in an efficient process.

In some such embodiments where the surface 28 of the initial portion 26 is foamed, a chemical blowing agent can be included in the elastomeric composition. The blowing agent can be dispersed throughout the initial portion 26 or concentrated near the surface 28 of the initial portion 26. In some such embodiments, the elastomeric composition includes a chemical blowing agent selected from the group of azo compounds, nitroso compounds, hydrazines, hydrazine derivatives, hydrogen carbonates, and combinations thereof. Specific non-limiting examples of such chemical blowing agents include, but are not limited to, azodicarbonamide (ADCA), N,N-dinitroso pentamethylene tetramine (DPT), 4. 4′-oxybis benzenesulfonyl hydrazide (OBSH), hydrazo dicarbonamide (HDCA), and sodium hydrogen carbonate (NaHCO₃). In some such embodiments, the chemical blowing agent is included in the elastomeric composition in an amount of from about 0.1 to about 50, alternatively from about 0.1 to about 25, alternatively from about 0.1 to about 10, alternatively from about 1 to about 25, alternatively from about 1 to about 20, alternatively from about 1 to about 10, alternatively from about 1 to about 5, alternatively from about 1 to about 7, alternatively from about 5 to about 15, alternatively from about 5 to about 10, parts by weight based on 100 parts by weight of the elastomeric composition.

In other alternative embodiments, the step of forming the plurality of engagement voids 20 comprises the steps of pressing a patterned mold into a surface 28 of an initial portion 26 comprising uncured elastomer, curing the initial portion 26 thereby forming the first portion 12 comprising the cured elastomer with the patterned mold thereon, removing the patterned mold to form the plurality of engagement voids 20 in the first portion 12 comprising cured elastomer.

The composite article 10 of the subject disclosure exhibits excellent adhesive properties—even at higher temperatures. In some embodiments, the composite article 10 has peel strength at least 2 times, alternatively 3 times, alternatively 4 times, alternatively 5 times, alternatively 6 times, alternatively 7 times, alternatively 8 times, alternatively 9 times, greater than the peel strength of a comparative composite article formed without a plurality of engagement voids but otherwise with the same process, when the testing is conducted at room temperature and in accordance with the T-peel test of ASTM D-1876 at a crosshead speed of 10 in/min. In some embodiments, the composite article 10 has peel strength at least 2 times, alternatively 3 times, alternatively 4 times, alternatively 5 times, alternatively 6 times, alternatively 7 times, greater than the peel strength of a comparative composite article formed without a plurality of engagement voids but otherwise with the same process, when the testing is conducted at 80° C. and in accordance with the T-peel test of ASTM D-1876 at a crosshead speed of 10 in/min.

In various embodiments, as part of the composite article 10, the composite article 10 can comprise more than two portions. If the composite article 10 includes more than two portions, at least two of the portions should be as described above. Composite articles of such configurations can be part of a larger whole, e.g. integrated into a product such as a tire, a raft, or food packaging.

The following examples are intended to illustrate the instant disclosure and are not to be viewed in any way as limiting to the scope of the instant disclosure.

### EXAMPLES

The composite article of Example 1 is in accordance with the subject disclosure. The composite articles of Comparative Examples 1-3 are for comparative purposes.

To form Example 1, a surface of a 4×4×0.1 inch initial portion of SBR 1 is coated with a thin layer of NaCl particles (1.3 g/in²) having an average particle size of about 200 microns. SBR 1 is an elastomeric composition comprising SBR, sulfur-based curatives, and additional additives. The samples were then pressed with 13 kN force for 30 minutes at 200° C. using a Carver press to cure the initial portion and form a first portion presenting an engagement surface.

The first portion was soaked for 16 hours in water, which dissolves the NaCl particles to provide a first portion presenting with the engagement surface having a plurality of engagement voids therein. Each engagement void penetrates into the engagement surface of the first portion and is defined by a side wall which forms an acute angle with the engagement surface. Each engagement void penetrates into the engagement surface of the first portion and is defined by a side wall which forms an acute angle with the engagement surface. Of course, not all of the voids formed in the engagement surface are engagement voids, i.e., not all of the voids formed form an acute angle with the engagement surface.

Once the first portion is formed, it is placed on an adjustable mold, with masking tape applied to one end of the engagement surface for purposes of peel testing. The adjustable mold is set to a thickness of 6 mm. A thermoplastic polyurethane (“TPU 1”) is injection molded/overmolded onto the engagement surface to form Example 1, a composite article comprising a first portion comprising cured rubber, and a second portion comprising TPU 1. A locking surface of the second portion of the composite article abuts the engagement surface and defines a plurality of locking protrusions disposed in the plurality of engagement voids of the first portion of the composite article. Example 1 is molded on a Cincinnati Milacron Injection Molding Vista 110-10, equipped with a 40 mm general purpose screw design and a L/D of 16/1 held within 3 barrels and a nozzle. The mold temperature is 30° C., the nozzle temperature is 210° C., and the sprue temperature is 215° C. during injection molding of the composite article. Example 1 is post cured for 20 hours at 100° C. This procedure is repeated 3 times to yield 3 samples of the composite article of Example 1.

TPU 1 is a polyester based TPU having the following physical properties:
Specific Gravity 1.21 g/cm³ (ASTM D 792);
Shore Hardness 95 A (ASTM D 2240 Shore A or D);
Taber Abrasion 30 mg loss (ASTM D 1044);
DIN Abrasion 25 mm³ loss (DIN 53516);
E-Modulus 9,000 PSI (ASTM D 412);
Flexural Modulus 11,000 PSI (ASTM D 790);
Tensile Strength 6,700 PSI (ASTM D 412);
Tensile Stress at 100% Elongation 2,200 PSI (ASTM D 412);
Tensile Stress at 300% Elongation 5,300 PSI (ASTM D 412);
Ultimate Elongation 440% (ASTM D 412);
Tear Strength 870 lb/in (ASTM D 624, Die C);
Compression Set 45% 22 h at 70° C. and 30% 22 h at 23° C. (ASTM D 395 “B”, % of original);
Glass Transition temperature* −36° C.;
Vicat Softening Temperature 135° C. (ASTM D 1525); and
DMA Softening Temperature* 123° C.
   Measured with Dynamic Mechanical Analysis (DMA).

A 1-inch wide strip is cut from each sample. Adhesion is measured using a T-peel test in accordance with ASTM D-1876 at a crosshead speed of 10 in/min. Peel testing is also conducted on Comparative Example 1, which is a composite article formed with the same materials as example 1, but with no engagement voids formed thereon. Peel testing is also conducted on Comparative Example 2, which is formed in accordance with the procedure above, but with a cured initial portion. Likewise, peel testing is conducted on Comparative Example 3, which is formed in accordance with the procedure above, but the salt is dissolved before the initial portion is cured. Peel testing results are set forth in Table 1 below, with the number shown being an average of three.

TABLE 1

| | Peel Strength (lbs/in) |
|---|---|
| Comparative Example 1 | 0.4 |
| Comparative Example 2 | 0.7 |
| Comparative Example 3 | 0.5 |
| Example 1 | 9.0 |

Referring now to Table 1 above, Example 1 exhibits superior peel strength over Comparative Examples 1-3. The step of curing the first portion with the NaCl particle therein is required and increases the peel strength by about 18 times.

The composite article of Example 2 is in accordance with the subject disclosure. The composite articles of Comparative Examples 4 and 5 are for comparative purposes.

To form Example 2, a surface of a 4×4×0.1 inch initial portion of SBR 2 is coated with a thin layer of NaCl particles (1.3 g/in²) having an average particle size of about 200 microns. SBR 1 is an elastomeric composition comprising SBR, sulfur-based curatives, and additional additives. The samples were then pressed with 5 kN force for 2 hours at 149° C. using a Carver press to cure the initial portion and form a first portion presenting an engagement surface.

The first portion was soaked for 16 hours in water, which dissolves the NaCl particles to provide a first portion presenting with the engagement surface having a plurality of engagement voids therein. Each engagement void penetrates into the engagement surface of the first portion and is defined by a side wall which forms an acute angle with the engagement surface. Each engagement void penetrates into the engagement surface of the first portion and is defined by a side wall which forms an acute angle with the engagement surface. Of course, not all of the voids formed in the engagement surface are engagement voids, i.e., not all of the voids formed form an acute angle with the engagement surface.

Once the first portion is formed, it is placed on an adjustable mold, with masking tape applied to one end of the engagement surface for purposes of peel testing. The adjustable mold is set to a thickness of 6 mm. A thermoplastic polyurethane (“TPU 2”) is injection molded/overmolded onto the engagement surface to form Example 2, a composite article comprising a first portion comprising cured rubber, and a second portion comprising TPU 2. A locking surface of the second portion of the composite article abuts the engagement surface and defines a plurality of locking protrusions disposed in the plurality of engagement voids of the first portion of the composite article. Example 2 is molded on a Cincinnati Milacron Injection Molding Vista 110-10, equipped with a 40 mm general purpose screw design and a L/D of 16/1 held within 3 barrels and a nozzle. The mold temperature is 30° C., the nozzle temperature is 210° C., and the sprue temperature is 215° C. during injection molding of the composite article. Example 2 is post cured for 20 hours at 50° C. This procedure is repeated 3 times to yield 3 samples of the composite article of Example 2.

TPU 1 is a polyether based TPU having the following physical properties:
Specific Gravity 1.13 g/cm³ (ASTM D 792);
Shore Hardness 90 A (ASTM D 2240 Shore A or D);
Taber Abrasion 45 mg loss (ASTM D 1044);
DIN Abrasion 25 mm³ loss (DIN 53516);
E-Modulus 4,500 PSI (ASTM D 412);
Flexural Modulus 4,200 PSI (ASTM D 790);
Tensile Strength 5,400 PSI (ASTM D 412);
Tensile Stress at 100% Elongation 1,800 PSI (ASTM D 412);
Tensile Stress at 300% Elongation 4,000 PSI (ASTM D 412);
Ultimate Elongation 460% (ASTM D 412);
Tear Strength 730 lb/in (ASTM D 624, Die C);
Compression Set 45% 22 h at 70° C. and 25% 22 h at 23° C. (ASTM D 395 “B”, % of original);
Glass Transition temperature* −35° C.;
Vicat Softening Temperature 120° C. (ASTM D 1525); and
DMA Softening Temperature* 100° C.
   *Measured with Dynamic Mechanical Analysis (DMA).

A 1-inch wide strip is cut from each sample. Adhesion is measured using a T-peel test in accordance with ASTM D-1876 at a crosshead speed of 10 in/min. Peel testing is also conducted on Comparative Example 4, which is a composite article formed with the same materials as Example 1, but with no engagement voids formed thereon. Peel testing is also conducted on Comparative Example 5, which is formed in accordance with the procedure above, but with a cured initial portion. Peel testing results are set forth in Table 2 below, with the number shown being an average of three.

TABLE 2

| | Peel Strength at Room | Peel Strength at 80° C. |
|---|---|---|
| | Temperature (lbs/in) | (lbs/in) |
| Comparative Example 4 | 1.96 | 0.806 |
| Comparative Example 5 | 2.212 | 0.733 |
| Example 2 | 6.918 | 1.59 |

Referring now to Table 2 above, Example 2 exhibits superior peel strength over Comparative Examples 4 and 5. The step of curing the first portion with the NaCl particle therein is required and increases the peel strength by 3 times. At high temperature (80° C.), a condition at which adhesion is particularly difficult to achieve, Example 2 exhibits about 2 times the peel strength of Comparative Examples 4 and 5.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Obviously, many modifications and variations of the present disclosure are possible in light of the above teachings. It is, therefore, to be understood that within the scope of the appended claims, the present disclosure may be practiced otherwise than as specifically described.

1. A method of forming a composite article including a first portion comprising a cured elastomer and presenting an engagement surface, and a second portion comprising a thermoplastic composition and presenting a locking surface, said method comprising the steps of:
forming a plurality of engagement voids in the first portion wherein each engagement void penetrates into the engagement surface of the first portion and is defined by a side wall which forms an acute angle with the engagement surface;
and applying the thermoplastic composition onto the engagement surface of the first portion to form the second portion such that the locking surface abuts the engagement surface and defines a plurality of locking protrusions disposed in the plurality of engagement voids of the first portion.

2. A method as set forth in claim 1 wherein the step of forming the plurality of engagement voids comprises the steps of:
pressing a plurality of particles into a surface of an initial portion comprising uncured elastomer;
curing the initial portion to form the first portion comprising the cured elastomer with the plurality of particles pressed therein;
and dissolving the plurality of particles in a solvent thereby forming the plurality of engagement voids in the first portion comprising cured elastomer.

3. A method as set forth in claim 2 wherein the plurality of particles have an average diameter of from about 10 to about 500 mm.

4. A method as set forth in claim 2 wherein the plurality of particles has a solubility of greater than about 1 g per 100 mL of the solvent at standard temperature and pressure.

5. A method as set forth in claim 2 wherein the solvent is a polar solvent.

6. A method as set forth in claim 2 wherein the particles comprise a salt selected from the group of nitrates, sulfates, chlorides, bromides, iodides, sodium carbonate, potassium carbonate, ammonium carbonate, sodium hydroxide, potassium hydroxide, and ammonium hydroxide.

7. A method as set forth in claim 2 wherein the particles comprise sodium chloride.

8. A method as set forth in claim 2 wherein the solvent comprises water.

9. A method as set forth in claim 1 wherein the step of forming the plurality of engagement voids comprises the steps of:
pressing a plurality of particles into a surface of an initial portion comprising uncured elastomer;
curing the initial portion to form the first portion comprising the cured elastomer with the plurality of particles therein;
and melting the plurality of particles in a solvent thereby forming the plurality of engagement voids in the first portion comprising cured elastomer.

10. A method as set forth in claim 9 wherein the plurality of particles have an average diameter of from about 10 to about 500 mm.

11. A method as set forth in claim 9 wherein the plurality of particles have a melting temperature of from about 100 to about 250° C.

12. A method as set forth in claim 9 wherein the steps of curing and melting are conducted simultaneously.

13. A method as set forth in claim 1 wherein the step of forming the plurality of engagement voids comprises the steps of:
pressing a patterned mold into a surface of an initial portion comprising uncured elastomer;
curing the initial portion thereby forming the first portion comprising the cured elastomer with the patterned mold thereon;
removing the patterned mold to form the plurality of engagement voids in the first portion comprising cured elastomer.

14. A method as set forth in claim 1 wherein the step of forming a plurality of engagement voids comprises the steps of:
foaming a surface of an initial portion comprising uncured elastomer;
curing the initial portion to form the plurality of engagement voids in the first portion comprising cured elastomer.

15. A method as set forth in claim 14 wherein the steps of foaming and curing are conducted simultaneously.

16. A method as set forth in claim 1 further comprising the step of pre-treating the engagement surface of the first portion with an adhesion promoter.

17. A method as set forth in claim 1 wherein the step of applying the thermoplastic composition onto the engagement surface of the first portion is conducted via injection molding.

18. A method as set forth in claim 1 wherein the cured elastomer comprises an elastomer selected from natural polyisoprene, synthetic polyisoprene, polybutadiene, chloroprene rubber, butyl rubber, halogenated butyl rubber, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, and ethylene-vinyl acetate.

19. (canceled)

20. A method as set forth in claim 1 wherein the thermoplastic composition comprises a thermoplastic elastomer selected from polyethylene, polypropylene, polyamide, or thermoplastic polyurethane.

21. A method as set forth in claim 1 wherein the first portion also defmes a plurality of voids that are different than the plurality of engagement voids, wherein each void defmes an opening in the engagement surface, penetrates into the first portion, and is defined by a side wall which does not form an acute angle with the engagement surface, and wherein the second portion defmes a plurality of protrusions disposed in the plurality of voids.

22. (canceled)

23. (canceled)

24. (canceled)
